(19) United States
(12) Patent Application Publication
(10) Pub. No.: US 2021/0292097 A1
(43) Pub. Date: Sep. 23, 2021

(54) SYSTEM FOR CONVEYING AN OBJECT USING A FREIGHT PARCEL TRANSPORTING A TEMPORARY PARCEL, WITH AUTOMATIC DETECTION OF THE DESTINATION OF THE TEMPORARY PARCEL

(71) Applicant: KEOPACK, Paris (FR)

(72) Inventors: Pascal Rozee, RULLY (FR); Patrick Kermaidic, TOULOUSE (FR)

(21) Appl. No.: 17/202,815

(22) Filed: Mar. 16, 2021

(30) Foreign Application Priority Data
Mar. 18, 2020 (FR) 2002661

(51) Int. Cl. B65G 43/00; G06K 7/10; G06K 7/14; G06Q 10/08

(52) U.S. Cl. CPC B65G 43/00; G06K 7/10366; B65G 2203/046; G06K 7/10297; G06Q 10/083; G06K 7/1413

(57) ABSTRACT

A system including a temporary parcel and a freight parcel. The temporary parcel includes a container, a closure having closed and opened configurations, and a device for detecting the closed or opened configuration. The freight parcel is able to contain the temporary parcel has an electronic display viewable from the outside of the freight parcel, and includes an information-technology unit parameterized to transmit display instructions to the electronic display. The temporary parcel carries a radio tag containing information on a postal address, and the freight parcel includes comprises a proximity transceiver to communicate with the radio tag and parameterised to read the postal address information. The electronic unit cooperates with the detection device for detecting the temporary parcel and is parameterized to enable a display, by the display device, of the postal address information on reception, by the information-technology unit, of closure information by the detection device.

### CROSS-REFERENCE TO RELATED APPLICATIONS

This application claims priority to French Patent Application FR2002661, filed Mar. 18, 2020, the content of which is incorporated herein by reference in its entirety.

### FIELD OF THE DISCLOSURE

The field of the invention is that of the design and manufacture of equipment dedicated to logistics.

More precisely, the invention relates to the conveying of objects, and in particular the conveying of objects generally coming from e-commerce platforms or transferred from one private individual to another.

### BACKGROUND OF THE DISCLOSURE

In the field of the invention, the conveying of objects by e-commerce platforms very often takes place by disposing the object or objects to be conveyed in a parcel provided, for the purpose of the conveying, with a label having at least one visual code, in particular taking the form of a printed bar code. This code makes it possible to identify the parcel by each of the actors being involved in the conveying of the parcel, and generally provides a postal address to which the object is intended to be sent.

In the field of the conveying of objects, it is a theme that relates to the redispatch of products, or more broadly of objects, with a view to recycling and/or disposal thereof.

In this regard, mention can be made in particular of:
used coffee capsules;
certain medical equipment, such as syringes;
out-of-date medicines;
etc.

At the present time, with some of these objects that are to be redispatched, it is found, and it is even regrettable, that the users of these objects do not take the time or do not make the effort to return these objects to the operator responsible for recycling or disposal thereof.

There therefore is a need, in terms of encouragement of the users of the objects that are to be redispatched, to proceed with the redispatch thereof.

At the same time, recently, connected parcels have made their appearance. These parcels are equipped with electronic display device visible from the outside of the parcel and intended to display a postal despatch address and optionally several other types of information. The display devices of these parcels may be programmed in order to enable the user of the parcel to activate a redispatch of the parcel to a predetermined deposit place, the deposit address then being displayed on the electronic display device.

In addition, because of the cost thereof, these “connected” parcels are produced from materials withstanding the various handlings (opening, closing, formation, etc.) and the various impacts liable to occur during their transport phase. In this way, these parcels are designed so as to be reused a large number of times.

Currently, such parcels are not used in a context of encouraging the redispatch of objects such as those mentioned previously.

In addition, some objects to be recycled or disposed of may have physical characteristics of such a nature as to damage and/or soil the parcel that transports them. This is because some objects may have forms of such a nature as to ruin the internal walls of the parcel (objects with projecting, or even sharp, edges, syringes, etc.) or to soil them (fatty objects, dripping objects, etc.). It is then quite obvious that this is contrary to the objective of multiple re-uses of the reusable connected parcels.

### SUMMARY

The objective of an exemplary embodiment of the invention is in particular to overcome one or more of the drawbacks or deficiencies of the prior art.

More precisely, the objective of an exemplary embodiment of the invention is to propose a system for conveying objects by means of reusable connected parcels that preserves the integrity of the parcel including with transported objects that are damaging for the parcel or soiling.

Another objective of an exemplary embodiment of the invention is to provide such a system that encourages consumers to return objects to be recycled or to be disposed of intended for a predetermined place of deposition.

Another object of an exemplary embodiment of the invention is to provide such a system that is simple to use for the users.

These objectives, as well as others that will emerge hereinafter, are achieved by means of an exemplary embodiment of the invention, the object of which is a system for conveying an object, using:
at least one temporary parcel comprising a container and a closure able, with the container, to adopt a closed configuration or an open configuration, the temporary parcel also comprising a device for detecting the closed or open configuration of the temporary parcel,
a freight parcel able to contain the temporary parcel or parcels and having an electronic display device that can be consulted from the outside of the freight parcel, and including an information-technology unit parameterised to transmit display instructions to the electronic display device,
   characterised in that the temporary parcel or parcels carry at least one radio tag containing information on the postal address for which the object is intended, and in that the freight parcel comprises a proximity transceiver, able to communicate with the radio tag and being parameterised to read the postal address information, the electronic unit of the freight parcel being able to cooperate with the device for detecting the temporary parcel or parcels and being connected to the display device, the electronic unit being parameterised to enable a display, by the display device, of the postal address information on reception of closure information by the detection device, the freight parcel is configured to fix and/or hold the temporary parcel.

Thus, by virtue of an exemplary embodiment of the invention, it is possible to transport, in a reusable connected parcel, hereinafter designated by the words “freight parcel”, objects liable to be damaging or soiling for the freight parcel. The physical integrity of the freight parcel is thus preserved, and the ability thereof to be reused multiple times, without requiring servicing or maintenance, is preserved.

This is because the products liable to be damaging or soiling for the freight parcel are confined inside the “temporary parcel” (or temporary parcels, if there are several of them disposed in the freight parcel), which in this way constitutes a protective enclosure for the internal space of the freight parcel.

Furthermore, the temporary parcels are programmed, by using of the radio tag that is associated therewith, with postal address data corresponding to a collection place dedicated to the process of recycling or disposing of the objects intended to be contained in the temporary parcel. These data are communicated to the freight parcel, which displays, on the display device, the postal address with which the temporary parcel has been programmed (by the affixing on the temporary parcel of the radio tag containing the destination address data).

It should be noted that this display is enabled only if the temporary parcel or parcels are correctly closed. In other words, it is ensured that the objects contained in the temporary parcels will not be extracted therefrom, which would annul the objective of protecting the freight parcel, since the objects could then be in direct contact with the internal space of the freight parcel.

Moreover, a conveying system according to the an exemplary embodiment of invention may prove to have a dimension of encouraging the redispatch of objects that are to be recycled or disposed of. This is because an object of this type can be delivered to a consumer with a temporary parcel programmed with the redispatch address corresponding to the object in question. It then suffices for the consumer to store the consumed objects in a temporary parcel, and then to place the latter correctly closed in a freight parcel, with a minimum of constraints and in very little time.

According to a first advantageous solution, the proximity transceiver is an RFID reader.

According to a second advantageous solution, the proximity transceiver is an NFC reader.

In either case, this type of proximity transceiver is very normal and can therefore be implemented inexpensively and in mass production.

According to a first approach, the detection device is mechanical.

According to a second approach, the detection defied is electronic.

According to a preferential solution, the temporary parcel or parcels are hermetic in the closed configuration thereof.

Thus it is possible to transport one or more products liable to diffuse a more or less soiling liquid, as is the case for example with used coffee capsules. Any liquid soiling is therefore confined in the temporary parcel and does not impair the integrity of the internal space of the freight parcel.

According to an advantageous solution, the temporary parcel comprises at least one sensor for complementary data, including:
a temperature in the temporary parcel;
a weight of the object or objects;
a degree of moisture in the temporary parcel;
a pressure in the temporary parcel;
an impact suffered by the temporary parcel;
a signal of opening of the temporary parcel.

With such complementary data, it is possible to check the transport conditions of the object or objects, and therefore to check whether the good preservation of the object or objects is ensured. Such complementary data may also serve to check that the temporary parcel is not degraded or opened, and therefore to check whether the object or objects are spreading inside the freight parcel with the risk of degrading or damaging the freight parcel.

According to an advantageous embodiment, the freight parcel comprises a communication device, the information-technology unit being parameterised in order to collect the complementary data and to send the complementary data to a remote unit, by using of the communication device.

### BRIEF DESCRIPTION OF THE DRAWINGS

Other features and advantages will emerge from a reading of the following description of an exemplary embodiment and of several of the variants thereof, given simply by way of illustrative and non-limitative example, and of the accompanying drawings, among which:

FIG. 1 is a schematic representation of a freight parcel of a system for conveying objects according to an exemplary embodiment of the invention.

FIG. 2 is a schematic representation of a temporary parcel for a system for conveying objects according to a first variant embodiment.

FIGS. 3 to 6 are each a schematic representation of a variant embodiment of a temporary parcel for a system for conveying objects.

### DETAILED DESCRIPTION OF ILLUSTRATIVE EMBODIMENTS

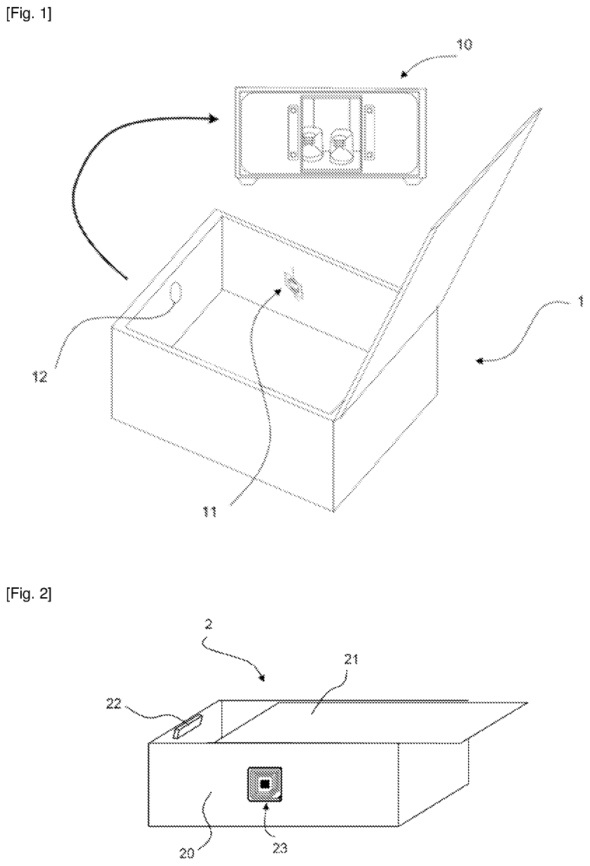

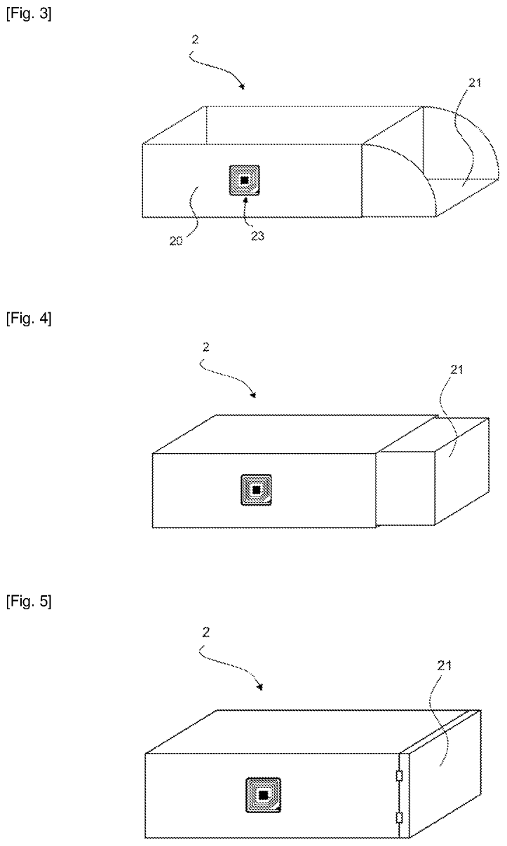

As illustrated by FIGS. 1 and 2, a conveying system according to an exemplary embodiment of the invention uses:
a freight parcel 1 having, on one of the external faces thereof, an electronic display device 10 (FIG. 1);
a temporary parcel 2, or several (FIG. 2), comprising a container 20 and closure 21 able to adopt, with the container, a closed configuration or an open configuration.

It should be noted that “freight parcel” means a packaged packet bearing the name and address of the destination so as to be conveyed by postal services or by an express delivery service (road transport or other) to its destination. As a result a “freight parcel” within the meaning of the invention has dimensions corresponding to the parcels as defined previously, or close to these dimensions. The same of course applies for the “temporary parcels” since these are sized so as to be able to be contained in the “freight parcels”.

It can however be envisaged, without departing from the scope of the invention, using freight parcels with larger dimensions so that they can contain a plurality of temporary parcels.

Boxes or cartons are conventionally employed for performing such parcels.

In the temporary parcel 2, a detection device 22 makes it possible to detect the closed configuration or the open configuration of the temporary parcel. As will be explained below, information on the configuration of the temporary parcel (open or closed) is sent by the detection device.

The freight parcel 1 is sized according to the shape and dimensions of the temporary parcel or parcels, so that the freight parcel is able to contain the temporary parcel or parcels.

In addition, the freight parcel includes an information-technology unit 11 parameterised to transmit display instructions to the electronic display device 10. Moreover, the freight parcel is configured to fix and/or hold the temporary parcel once the latter is disposed in the freight parcel.

According to the principle of an exemplary embodiment of the invention, a temporary parcel carries a radio tag 23, or even several, this radio tag being programmed with data comprising a postal address for which the object contained in the temporary parcel is intended.

In addition, the freight parcel 1 comprises a proximity transceiver 12, able to communicate with the radio tag 23 of the temporary parcel. According to a known operating principle, this proximity transceiver is parameterised to read the content of the radio tag 23, in this case the postal address information.

The electronic unit 11 of the freight parcel is also able to cooperate with the detection device of the temporary parcel, in order to receive the information sent by the detection device with regard to the open or closed configuration of the temporary parcel.

Thus, on reception by the electronic unit of the freight parcel of closure information by the detection device, the electronic unit 11, connected to the display device 10, is parameterised in order to enable a display, by the electronic display device 10, of the postal address information contained in the radio tag 23.

In other words, according to the principle of an exemplary embodiment of the invention, once the temporary parcel is disposed in the freight parcel, the electronic unit of the freight parcel detects whether the temporary parcel is in the closed configuration. If such is the case, the information from the radio tag read by the proximity transceiver of the freight parcel is communicated to the electronic unit, which transmits it, for display, to the electronic display device that can be consulted from outside the freight parcel.

The freight parcel is thus automatically configured with the destination address of the object corresponding to the temporary parcel wherein the object is disposed.

One example of use, applied to coffee capsules, is explained below.

In this example, the new coffee capsules are sent to the consumer by being disposed in a temporary parcel, itself integrated in a freight parcel. He removes, for storage, the new capsules from the temporary parcel and returns, or not, the freight parcel to the sender. As the capsules are consumed, the consumer disposes the used capsules in the temporary parcel. Once the temporary parcel is full, he closes the temporary parcel again and repositions it in the freight parcel that he will have kept (or sends a request via, for example, an application on his smartphone in order to receive a new freight parcel). Once the temporary parcel has been correctly closed and positioned in the freight parcel, the latter recognises the temporary parcel and the destination postal address of the freight parcel is automatically displayed on the electronic display device of the freight parcel.

Optionally, once the freight parcel arrives at its destination, an automatic message can be sent to the consumer in order to indicate to him that the capsules have arrived at their destination and will be recycled.

With regard to the proximity transceiver included in the freight parcel, this may be a reader of the RFID type or of the NFC type.

The detection device of the temporary parcel may be of the mechanical type (being however coupled to an electronic component able to transmit closure information to the electronic unit of the freight parcel).

Preferentially, the detection device is of the electronic type, using a switch (or electronic switch) or a Hall effect sensor, connected to the electronic unit of the freight parcel, by the sending of a signal to the electronic unit relating to the closed or open configuration of the temporary parcel.

Moreover, the temporary parcel or parcels are hermetic in their closed configuration. For this purpose, it may include a seal system on the container and/or on the closure.

As indicated previously, the maintenance of the closed configuration of the temporary parcel is checked throughout the conveying of the freight parcel. If a problem of impermeability is detected, related in this case to the opening of the temporary parcel, an alert in the form of a signal can be sent to a remote unit (that of a manufacturer and/or that of a collection place for the recycling of the objects. For this purpose, the freight parcel comprises a communication device and the information-technology unit is parameterised to collect the data relating to the impermeability and more particularly relating to the opening of the temporary parcel.

By means of the communication device of the freight parcel, the information-technology unit may therefore send, to the remote unit, and by means of the communication device, complementary data including:
a temperature in the temporary parcel;
a weight of the object or objects;
a degree of moisture in the temporary parcel;
a pressure in the temporary parcel;
an impact suffered by the temporary parcel.

Naturally, in this case, the freight parcel includes the ad hoc sensors for taking the measurements of complementary data.

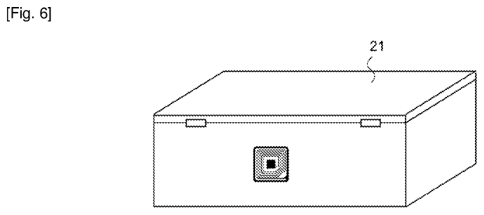

It should be noted that the temporary parcel may take various forms, and in particular those illustrated by FIGS. 3 to 6.

As illustrated by FIG. 3, the closure may take the form of a pivoting flap, present at one end of the container 20 in this case taking a parallelepipedal form.

The closure 21 may take the form of a drawer sliding inside the container, as illustrated by FIG. 4.

The closure 21 may take the form of a lid mechanically coupled to the end of the parallelepipedal container 20 as illustrated by FIG. 5, or on the top of the container as illustrated by FIG. 6.

It should be noted that the temporary parcel may have dimensions and shape adapted for fitting in the freight parcel, this while being in contact with each of the internal walls of the freight parcel. In this way, the temporary parcel is directly wedged inside the freight parcel, against the internal walls thereof. Naturally, this embodiment is not exclusive of other elements for fixing integrated in the freight parcel.

According to another example, the temporary parcel may be formed by a flexible bag, for example plasticised, which defines the cavity intended to receive the object or objects. In this case, the closure may for example be formed by an adhesive film affixed to the bag previously folded on itself in order to enclose an opening affording access to the cavity. The closure may also consist of an excess fold of material forming the bag and intended to be folded over the opening and then glued onto the flexible bag.

Although the present disclosure has been described with reference to one or more examples, workers skilled in the art will recognize that changes may be made in form and detail without departing from the scope of the disclosure and/or the appended claims.

1. A system for conveying an object, comprising:
at least one temporary parcel comprising a container and a closure able, with the container, to adopt a closed configuration or an open configuration, the temporary parcel also comprising a detection device for detecting the closed or open configuration of the temporary parcel, and
a freight parcel able to contain the at least one temporary parcel and having an electronic display device that is viewable from an outside of the freight parcel, and including an information-technology unit parameterised to transmit display instructions to the electronic display device,
wherein the at least one temporary parcel carries at least one radio tag containing information on a postal address for which the object is intended,
the freight parcel comprises a proximity transceiver able to communicate with the radio tag and being parameterised to read the postal address,
the electronic unit of the freight parcel is able to cooperate with the detection device for detecting the at least one temporary parcel, the electronic unit being parameterised to enable a display, by the display device, of the postal address on reception, by the information-technology unit, of closure information by the detection device, and
the freight parcel is configured to fix or hold the temporary parcel.

2. The system according to claim 1, wherein the proximity transceiver comprises an RFID reader.

3. The system according to claim 1, wherein the proximity transceiver comprises an NFC reader.

4. The system according to claim 1, wherein the detection device is mechanical.

5. The system according to claim 1, wherein the detection device is electronic.

6. The system for conveying an object according to claim 1, wherein the at least one temporary parcel is hermetic in the closed configuration.

7. The system according to claim 1, wherein the at least one temporary parcel comprises at least one sensor for complementary data selected from the group consisting of:
a temperature in the temporary parcel;
a weight of the object or objects;
a degree of moisture in the temporary parcel;
a pressure in the temporary parcel;
an impact suffered by the temporary parcel;
a signal of opening of the temporary parcel.

8. The system according to claim 7, wherein the freight parcel comprises a communication device, the information-technology unit being parameterised for collecting the complementary data and sending the complementary data to a remote unit by using the communication device.
